(19) United States
(12) Patent Application Publication
(10) Pub. No.: US 2010/0024369 A1
(43) Pub. Date: Feb. 4, 2010

(54) Air Filter Housing for a Cylindrical Filter Element

(75) Inventors: Klemens Dworatzek, Edingen (DE); Ralf Bauder, Ketsch (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/376,189

(22) PCT Filed: Jul. 12, 2007
(86) PCT No.: PCT/EP2007/057201

§ 371 Date: Apr. 28, 2009

(30) Foreign Application Priority Data
Aug. 3, 2006 (DE) 20 2006 011 994.9

(51) Int. Cl. B01D 46/42

(52) U.S. Cl. 55/490

(57) ABSTRACT

In order to be able to adjust in a simple and inexpensive way in the manufacture of an air filter housing (10) for a cylindrical filter element, the housing comprising a tangentially adjoining unfiltered air socket (1) and an outlet socket (2) and comprising a footstep bearing element (3) formed integrally on the air filter housing, the angular position of the unfiltered air socket (1) relative to a support and fastening plane predetermined by the footstep bearing elements (3), it is provided that the air filter housing is divided into a central housing element (4), on which the footstep bearing element (3) is integrally formed, and an intake element (5), on which the unfiltered air socket (1) is integrally formed, wherein the central housing element (4) and the intake element (5) are connected to one another by a rotationally positionable connection.

### TECHNICAL FIELD

The invention concerns an air filter housing for a cylindrical air filter element, comprising an unfiltered air socket adjoining tangentially the air filter housing and an outlet socket and comprising at least one footstep bearing element integrally formed on the air filter housing.

### PRIOR ART

Such air filter housings are known. They have the advantage that by means of the integrally formed footstep bearing elements an attachment is possible directly on a support. A separate attachment by means of tightening belts or the like is no longer required. The air filter housing can be produced together with the footstep bearing elements and intake and outlet sockets, for example, by injection moulding. In this connection, it is in general of a cup-shaped configuration, i.e., open at one end, in order to be able to remove the filter element. The open end is then closed off by a cover.

A disadvantage is however that the integral configuration predetermines the angular position of the intake socket relative to the footstep bearing elements. For various machine types where different spatial conditions are present, an adjustment of the tangential angle between the intake socket and the support plane of the footstep bearing elements can be effected only by changing the injection mold or by a separate injection mold, causing corresponding costs. For small production series in case of construction machinery produced only in small numbers, this is not economical.

The object of the invention is therefore to improve the known air filter housing in such a way that a simpler adjustment to spatial conditions of the mounting space is possible.

### SUMMARY OF THE INVENTION

This object is solved for an air filter housing of the aforementioned kind in such a way that the air filter housing is divided into a central housing element on which the footstep bearing element is integrally formed and an intake element on which the unfiltered air socket is integrally formed wherein the central housing element and the intake element are connected to one another by a rotationally positionable connection.

By providing two parts, the angular position between the intake element with the tangentially adjoining intake socket and the central housing element with the least one footstep bearing element can be selected freely upon assembly. No additional mold costs are required in order to produce a variety of socket positions on the housing.

The rotationally positionable connection can be, for example, formed by a weld connection or a snap-on connection. In this way, the position of the unfiltered air socket relative to the footstep bearing elements can be adjusted before, during or after joining the housing parts. Preferably, the position of the unfiltered air socket relative to the footstep bearing element is fixed after completion of the joining process so that an accidental rotation of the housing parts is prevented.

In a special configuration of the invention the weld connection is a friction weld connection where joining areas on the housing parts are melted and subsequently pressed against one another.

In an alternative embodiment of the invention the snap-on connection is an annular snap-on connection.

According to a special embodiment a non-detachable annular connection with high clamping forces is provided that has the effect that an accidental rotation of the intake element relative to the central housing element is prevented when being mounted in a vehicle or the like. By high clamping forces an accidental detachment of the two housing elements from one another is also prevented. Finally, with an appropriately strong snap-on connection a satisfactory air tightness for an air filter housing can also be effected so that no additional sealing means at the joining location are required. This effect can be achieved also by a weld connection that is appropriately embodied to be seal-tight.

### BRIEF DESCRIPTION OF THE DRAWINGS

The invention will be explained in the following with one embodiment in more detail. The Figures show in perspective illustration, respectively, in

FIG. 1 an assembled air filter housing;

FIG. 2 the air filter housing of FIG. 1 before joining the housing elements;

FIGS. 3, 4 the air filter housing with further angular positions of the intake socket relative to the footstep bearing elements; and

FIG. 5 details of an additional locking connection.

### EMBODIMENTS(S) OF THE INVENTION

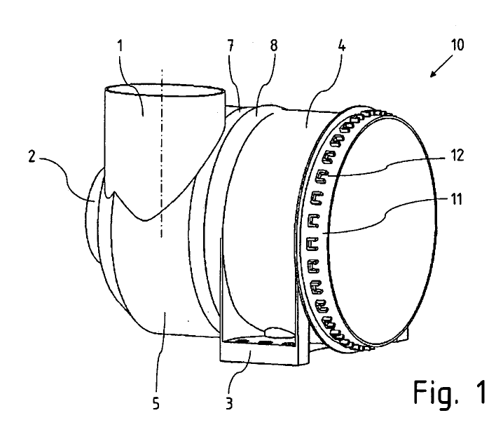

FIG. 1 shows an air filter housing 10 with an intake socket 1 and a central outlet socket 2.

In the illustrated embodiment the air filter housing is configured as a generally known two-stage air filter with preseparation of dust. Air is introduced here tangentially through the intake socket 1 and then rotates about a filter element, not illustrated, wherein coarse dust particles are thrown off and guided out of the housing. The thus pre-filtered air passes through the filter medium of the filter element that is inserted into the interior of the air filter housing 10 and flows through a central outlet socket 2 out of the air filter housing.

By means of the footstep bearing elements 3 that are integrally formed on the outer circumference of the housing body an immediate mounting is possible on a support surface that is provided by means of a mounting bracket or the like in the engine compartment. In the illustrated embodiment the central axis of the intake socket 1 extends perpendicularly to the support plane predetermined by the footstep bearing elements 3.

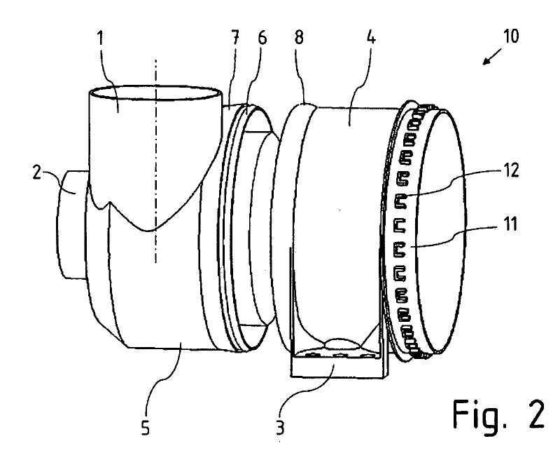

This angle, as illustrated in particular in FIG. 2, is effected by an appropriate positioning of the central housing element 4 and the intake element 5 relative to one another before the parts are joined. In the illustrated embodiment the intake element has a terminal part 7 that tapers into a wedge-shaped snap-on rib 6. The central housing element 4 has a receiving collar 8 that has a diameter that relative to the remaining sections of the substantially cylindrical housing wall is widened and that is undercut at its inner circumference so that the snap-on rib 6 can be inserted where it is locked. A smooth transition between the respective terminal parts 7, 8 of the housing elements 4, 5 provides no points of attack for a lever action tool and therefore makes the snap-on connection between the housing element 4, 5 essentially non-detachable.

A reverse arrangement of the snap-on rib and the receiving collar is possible.

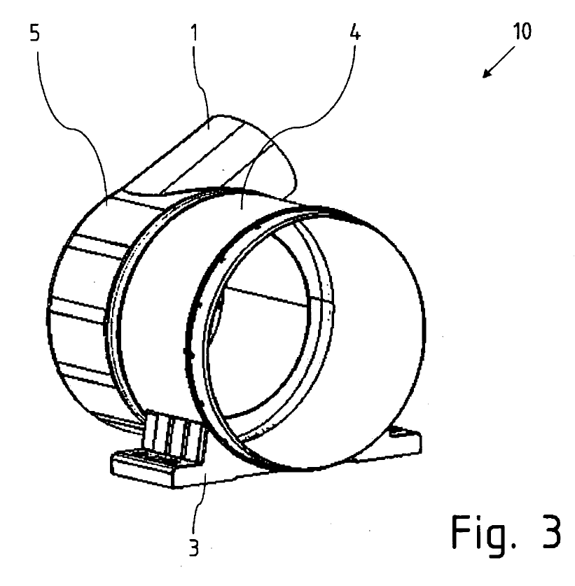

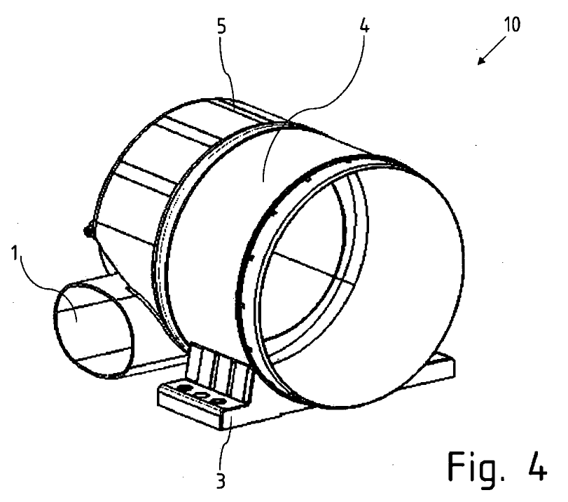

FIGS. 3 and 4 each show an air filter housing 10 that is comprised of the same housing elements 4, 5 as in the afore described embodiment. The difference is only that the intake housing element 5 with intake socket 1 and the central housing 4 with the footstep bearing elements 3 are positioned at a different angle relative to one another in order to provide an adjustment to the spatial conditions of the machines where the air filter housing is to be mounted. In the example of FIG. 3, the intake socket 1 is adjusted at a slantedly projecting angle; in FIG. 4 the intake socket extends parallel to the support or attachment plane.

The open end of the air filter housing 10 can be closed off in a generally known way by a screw lid or by means of a lid that is pressed by means of locking connections provided laterally on the air filter housing onto the central housing element.

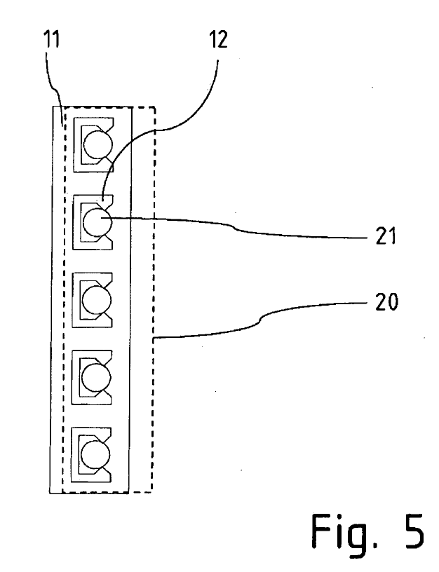

It is also possible to provide locking receptacles 12 at uniform angular spacings on the terminal projection 11 as shown in the FIGS. 1 and 2 and illustrated in detail in FIG. 5. On the inner circumference of the lid 20 matching counter members are integrally formed that, for example, are in the form of cylindrical projections 21 that can be inserted into the locking receptacles 12 embodied in a bracket shape in the embodiment of FIG. 5 so that the lid 20 can be locked on the central housing element 4 by insertion in the axial direction. By a fine angular division a great variability in regard to positioning of the lid is effected in order to be able to adjust also its angular position in the mounting space, for example, in case this should be required on the lid because of elements that are not of rotational symmetry. By the great number of locking connections along the circumference satisfactorily high securing forces are provided in order to keep the lid 20 safely on the housing 10 at operating pressure.

Instead of the snap-on connection, the housing parts 4, 5 can also be connected by a weld connection. In this connection, instead of the snap-on rib 6 and the receiving collar 8 a corresponding weld rim for melting and for receiving the melt is provided.

1. Air filter housing (10) for a cylindrical filter element, comprising an unfiltered air socket (1) adjoining tangentially the air filter housing (10) and an outlet socket (2) and comprising at least one footstep bearing element (3) formed integrally on the air filter housing (10), characterized in that the air filter housing (10) is divided into a central housing element (4), on which the footstep bearing element (3) is integrally formed, and an intake element (5), on which the unfiltered air socket (1) is integrally formed, wherein the central housing element (4) and the intake element (5) are connected by a rotationally positionable connection with one another.

2. Air filter housing (10) according to claim 1, characterized in that the rotationally positionable connection is a weld connection.

3. Air filter housing (10) according to claim 2, characterized in that the weld connection is a friction weld connection.

4. Air filter housing (10) according to claim 1, characterized in that the rotationally positionable connection is a snap-on connection.

5. Air filter housing (10) according to claim 4, characterized in that the snap-on connection is an annular snap-on connection that is formed by a snap-on rib (6) on a terminal part (7) of one of the housing elements (4, 5) and a receiving collar (8) on the other housing element (4, 5), respectively.

6. Air filter housing (10) according to claim 5, characterized in that the terminal part (7) and the receiving collar (8) pass continuously into one another.

7. Air filter housing (10) according to one of the claims 1 to 6, characterized in that the outlet socket (2) extends away centrally from an end face of the intake element (5).

8. Air filter housing (10) according to one of the claims 4 to 7, characterized in that along the circumference of a terminal projection (11) of a housing element (4) that is open at one end face a plurality of locking receptacles (12) are arranged and in that a lid (20) for closing off the housing is provided that has on its inner circumference several locking projections (21) that are lockable in the locking receptacles (12).
